(19) United States
(12) Patent Application Publication
(10) Pub. No.: US 2024/0257012 A1
(43) Pub. Date: Aug. 1, 2024

(54) DYNAMIC QUESTIONING INTELLIGENCE

(71) Applicant: Dell Products L.P., Round Rock, TX (US)

(72) Inventors: Stephen James Todd, North Andover, MA (US); David Edward Frattura, Stamford, CT (US); Eloy Francisco Macha, Crowley, TX (US); Robert Anthony Lincourt, JR., Franklin, MA (US)

(21) Appl. No.: 18/162,233

(22) Filed: Jan. 31, 2023

(51) Int. Cl. G06Q 10/0637

(52) U.S. Cl. CPC G06Q 10/0637

(57) ABSTRACT

A method and system for dynamic questioning intelligence. Every year, conferences are attended by droves of participants, where most of those that attend reflect some interest and/or involvement in the theme(s) on which said conferences may be centered. Further, as these participants return from attending said conferences, some are expected to report on their respective experiences and observations. Existing systems/solutions directed to facilitating the capture of a participant's said experiences and observations often, if not always, provide pre-canned questions to gather pre-determined types of answers, which ultimately limit the potential knowledge and value that the participant could bring back to their respective organization. As an improvement over these existing systems/solutions, embodiments disclosed herein leverage a vast collection of insight state, as well as a user business intent for a participant, in order to customize conference-directed interview questions and present said questions, through a more human-conversational manner, to the participant.

### BACKGROUND

Organization strategy may reference a plan (or a sum of actions), intended to be pursued by an organization, directed to leveraging organization resources towards achieving one or more long-term goals. Said long-term goal(s) may, for example, relate to identifying or predicting future or emergent trends across one or more industries. Digitally-assisted organization strategy, meanwhile, references the scheming and/or implementation of organization strategy, at least in part, through insights distilled by artificial intelligence.

### SUMMARY

In general, in one aspect, embodiments disclosed herein relate to a method for intelligent dynamic questioning. The method includes: detecting an initiation, by an organization user, of a conference interview program configured to question the organization user about a conference attended thereby; obtaining a user business intent for the organization user; building a conference model for the conference; performing a pre-work pipeline, using the user business intent, the conference model, and an insight state, to produce a pre-work result; generating a set of user-tailored interview questions based on the pre-work result and considering the user business intent; and providing, through the conference interview program, the set of user-tailored interview questions to the organization user.

In general, in one aspect, embodiments disclosed herein relate to a non-transitory computer readable medium (CRM). The non-transitory CRM includes computer readable program code, which when executed by a computer processor, enables the computer processor to perform a method for intelligent dynamic questioning. The method includes: detecting an initiation, by an organization user, of a conference interview program configured to question the organization user about a conference attended thereby; obtaining a user business intent for the organization user; building a conference model for the conference; performing a pre-work pipeline, using the user business intent, the conference model, and an insight state, to produce a pre-work result; generating a set of user-tailored interview questions based on the pre-work result and considering the user business intent; and providing, through the conference interview program, the set of user-tailored interview questions to the organization user.

In general, in one aspect, embodiments disclosed herein relate to a system. The system includes: a client device; and an insight service operatively connected to the client device, and including a computer processor configured to perform a method for intelligent dynamic questioning. The method includes: detecting an initiation, by an organization user operating the client device, of a conference interview program configured to question the organization user about a conference attended thereby, wherein the conference interview program is executing on the client device; obtaining a user business intent for the organization user; building a conference model for the conference; performing a pre-work pipeline, using the user business intent, the conference model, and an insight state, to produce a pre-work result; generating a set of user-tailored interview questions based on the pre-work result and considering the user business intent; and providing, through the conference interview program, the set of user-tailored interview questions to the organization user.

Other aspects disclosed herein will be apparent from the following description and the appended claims.

### BRIEF DESCRIPTION OF DRAWINGS

FIG. 1A shows a system in accordance with one or more embodiments disclosed herein.

FIG. 1B shows a client device in accordance with one or more embodiments disclosed herein.

FIG. 2A shows an example connected graph in accordance with one or more embodiments disclosed herein.

FIGS. 2B-2D show example k-partite connected graphs in accordance with one or more embodiments disclosed herein.

FIGS. 3A and 3B show flowcharts describing a method for dynamic questioning intelligence in accordance with one or more embodiments disclosed herein.

FIGS. 3C and 3D show flowcharts describing a method for performing a pre-work pipeline in accordance with one or more embodiments disclosed herein.

FIG. 4 shows an example computing system in accordance with one or more embodiments disclosed herein.

FIGS. 5A-5R show an example scenario in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding disclosed herein. However, it will be apparent to one of ordinary skill in the art that the embodiments disclosed herein may be practiced without these specific details. In other instances, well-known features have not been described in detail to avoid unnecessarily complicating the description.

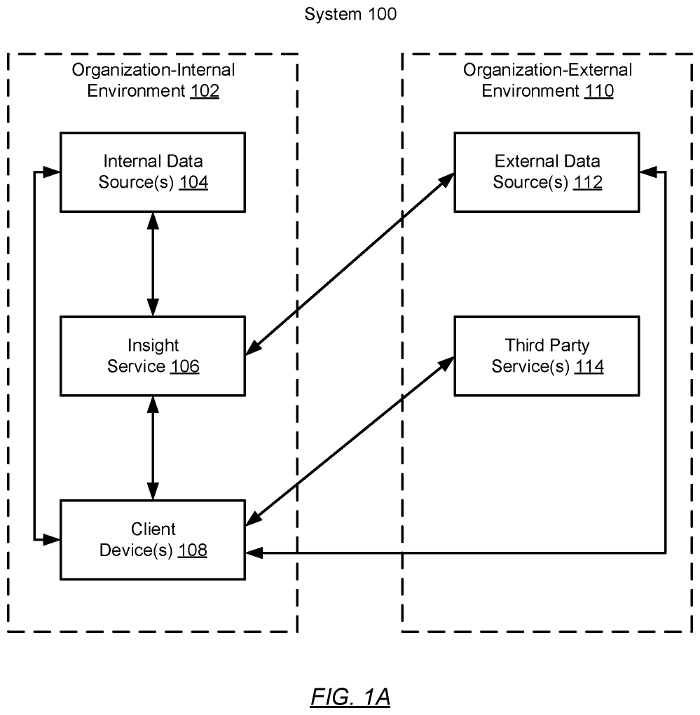

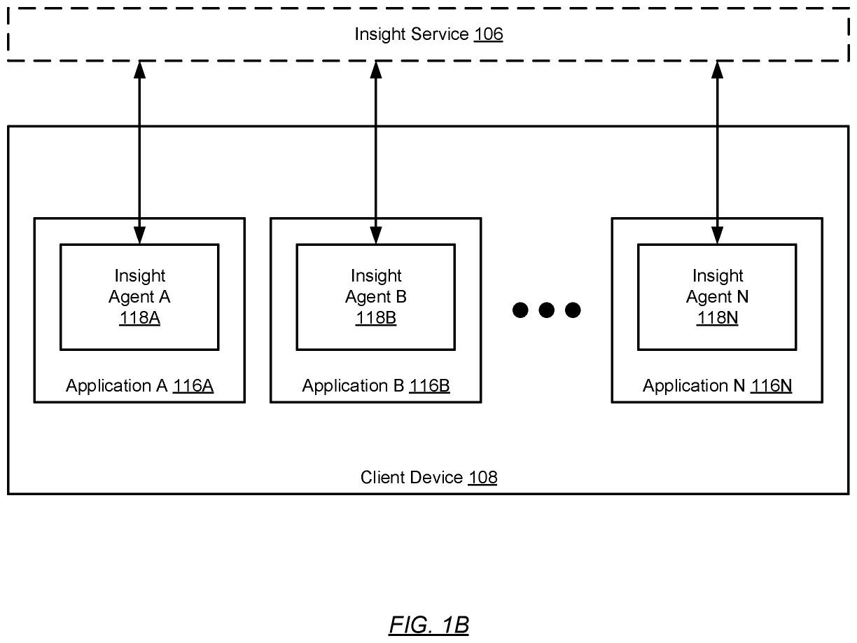

In the following description of FIGS. 1A-5R, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments disclosed herein relate to dynamic questioning intelligence. Every year, an assortment of conferences (or other engagements) are attended by droves of participants, where most of those that attend, as an extension of their respective organizations, reflect some interest and/or involvement in the theme(s) on which said conferences/engagements may be centered. Further, as these participants return from attending said conferences/engagements, at least a portion of them are expected to report on their respective experiences and observations. Existing systems (or solutions) directed to facilitating the capture of a participant's said experiences and observations often, if not always, provide pre-canned, static questions to gather pre-determined types of answers, which ultimately limit the potential knowledge and value that the participant could bring back to their respective organization. As an improvement over these existing systems/solutions, embodiments disclosed herein, accordingly, leverages a vast collection of insight state, as well as a user business intent for a participant, in order to customize conference/engagement-directed interview questions and present said questions, through a more human-conversational manner, to the participant.

FIG. 1A shows a system in accordance with one or more embodiments disclosed herein. The system (100) may include an organization-internal environment (102) and an organization-external environment (110). Each of these system (100) components is described below.

In one or many embodiment(s) disclosed herein, the organization-internal environment (102) may represent any digital (e.g., information technology (IT)) ecosystem belonging to, and thus managed by, an organization. Examples of said organization may include, but are not limited to, a business/commercial entity, a higher education school, a government agency, and a research institute. The organization-internal environment (102), accordingly, may at least reference one or more data centers of which the organization is the proprietor. Further, the organization-internal environment (102) may include one or more internal data sources (104), an insight service (106), and one or more client devices (108). Each of these organization-internal environment (102) subcomponents may or may not be co-located, and thus reside and/or operate, in the same physical or geographical space. Moreover, each of these organization-internal environment (102) subcomponents is described below.

In one or many embodiment(s) disclosed herein, an internal data source (104) may represent any data source belonging to, and thus managed by, the above-mentioned organization. A data source, in turn, may generally refer to a location where data or information (also referred to herein as one or more assets) resides. An asset, accordingly, may be exemplified through structured data/information (e.g., tabular data/information or a dataset) or through unstructured data/information (e.g., text, an image, audio, a video, an animation, multimedia, etc.). Furthermore, any internal data source (104), more specially, may refer to a location that stores at least a portion of the asset(s) generated, modified, or otherwise interacted with, solely by entities (e.g., the insight service (106) and/or the client device(s) (108)) within the organization-internal environment (102). Entities outside the organization-internal environment may not be permitted to access any internal data source (104) and, therefore, may not be permitted to access any asset(s) maintained therein.

Moreover, in one or many embodiment(s) disclosed herein, any internal data source (104) may be implemented as physical storage (and/or as logical/virtual storage spanning at least a portion of the physical storage). The physical storage may, at least in part, include persistent storage, where examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) disclosed herein, the insight service (106) may represent information technology infrastructure configured for digitally-assisted organization strategy. In brief, organization strategy may reference a plan (or a sum of actions), intended to be pursued by an organization, directed to leveraging organization resources towards achieving one or more long-term goals. Said long-term goal(s) may, for example, relate to identifying or predicting future or emergent trends across one or more industries. Digitally-assisted organization strategy, meanwhile, references the scheming and/or implementation of organization strategy, at least in part, through insights distilled by artificial intelligence. An insight, in turn, may be defined as a finding (or more broadly, as useful knowledge) gained through data analytics or, more precisely, through the discovery of patterns and/or relationships amongst an assortment of data/information (e.g., assets). The insight service (106), accordingly, may employ artificial intelligence to ingest assets maintained across various data sources (e.g., one or more internal data sources (104) and/or one or more external data sources (112)) and, subsequently, derive or infer insights therefrom that are supportive of an organization strategy for an organization.

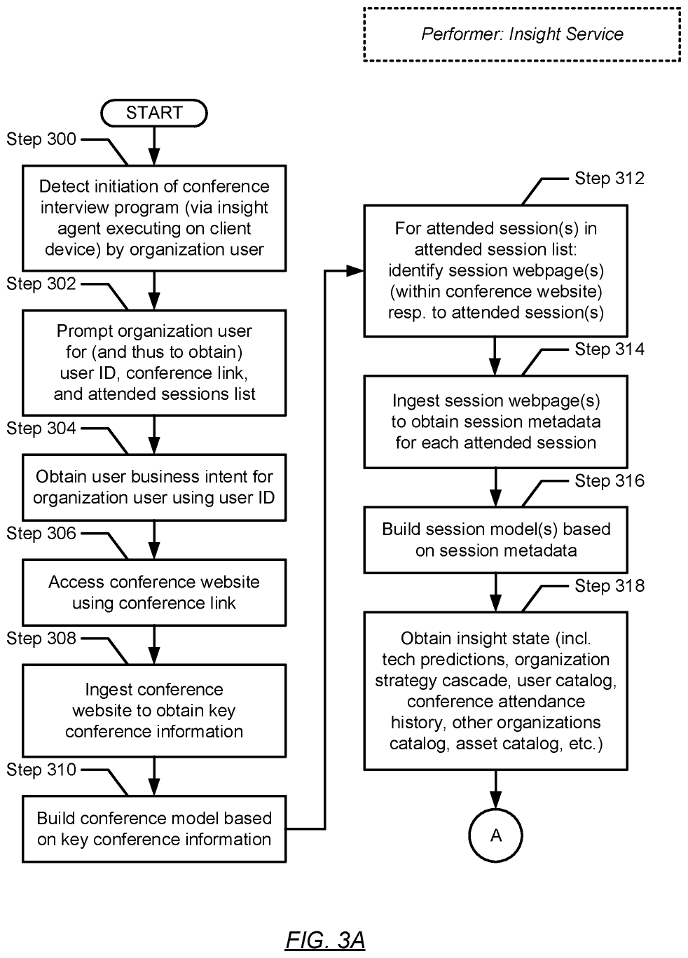

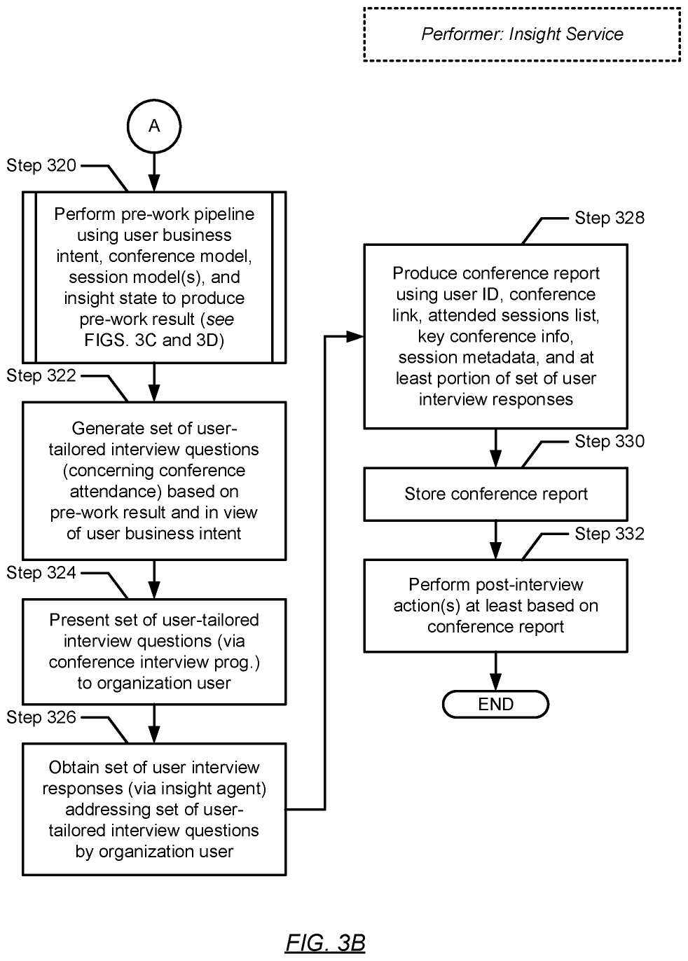

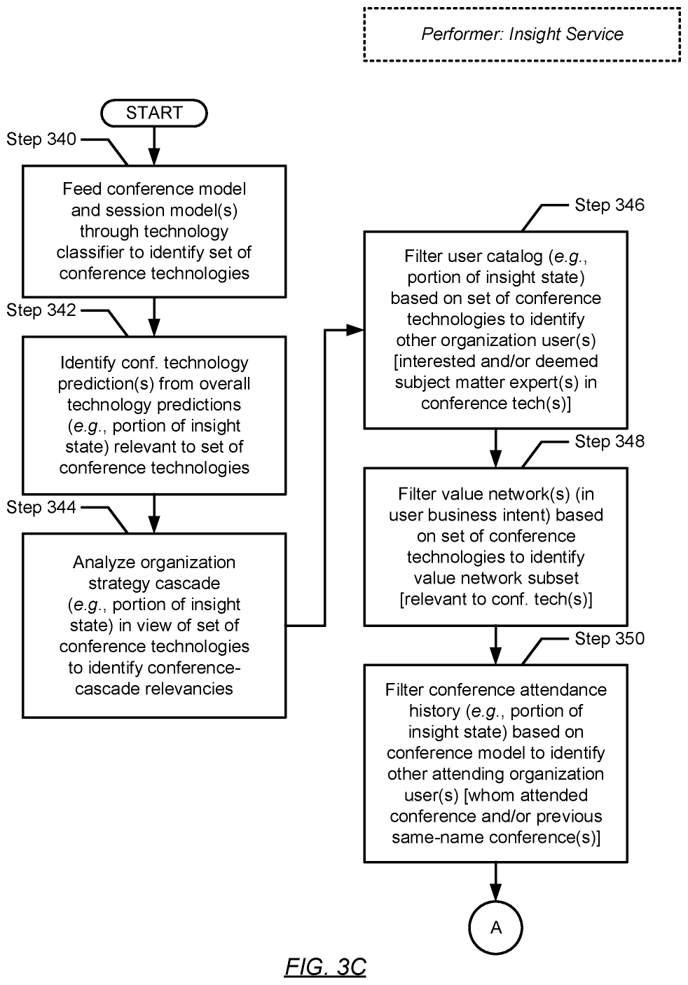

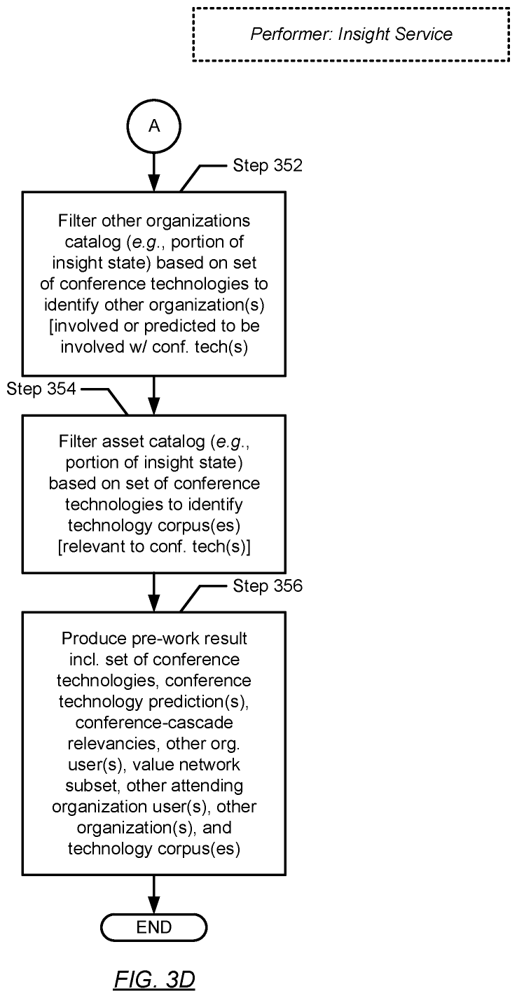

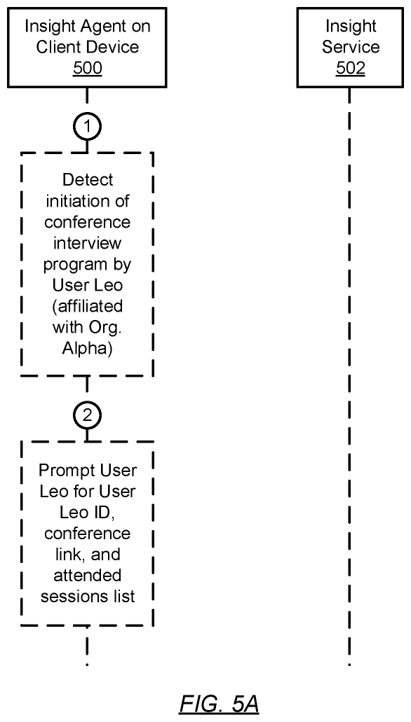

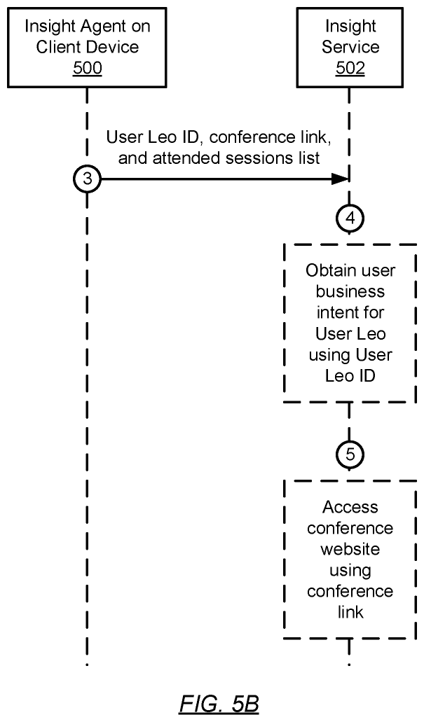

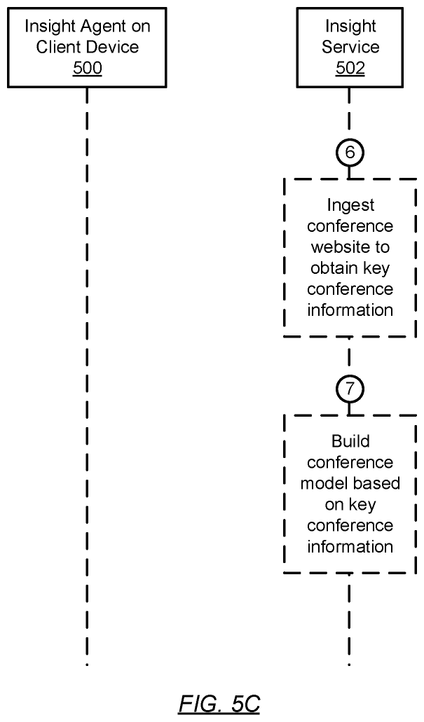

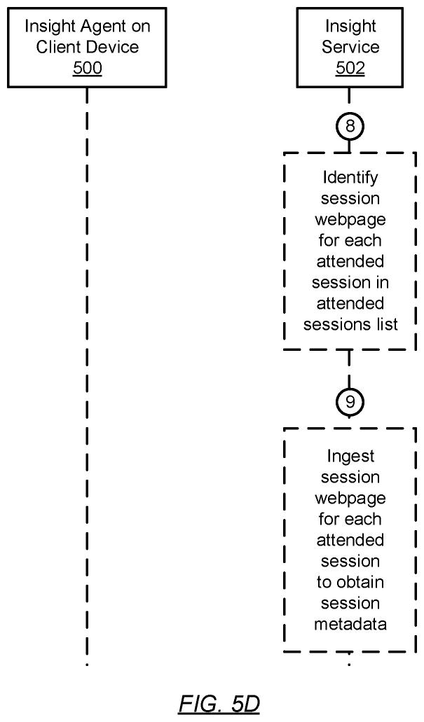

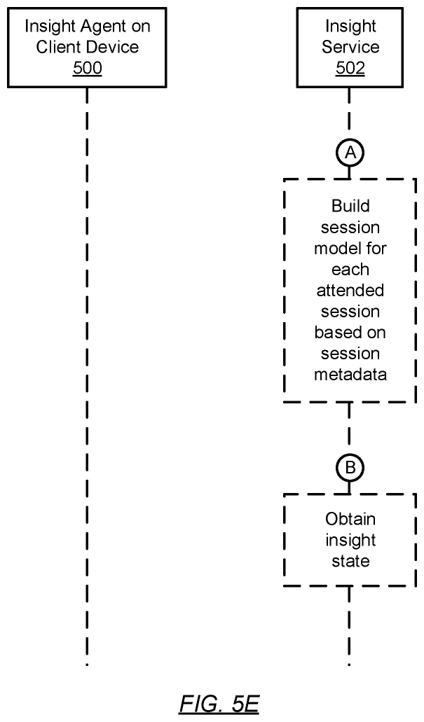

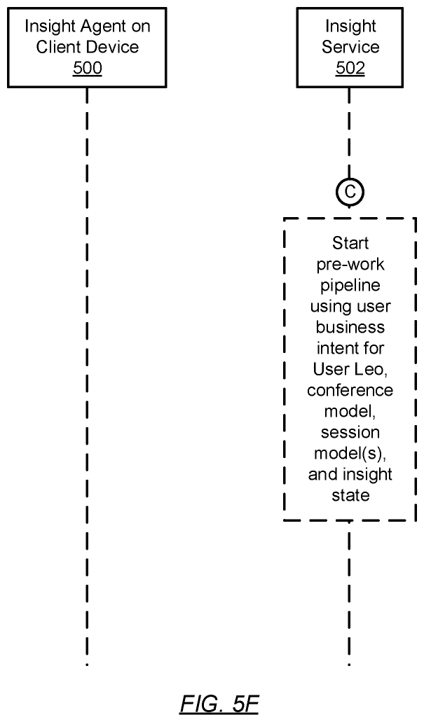

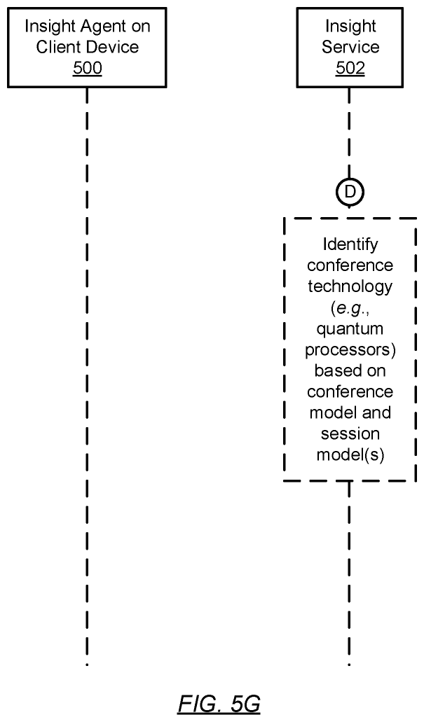

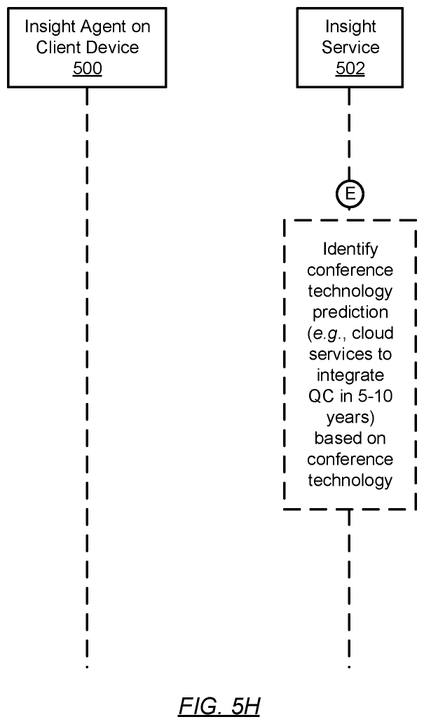

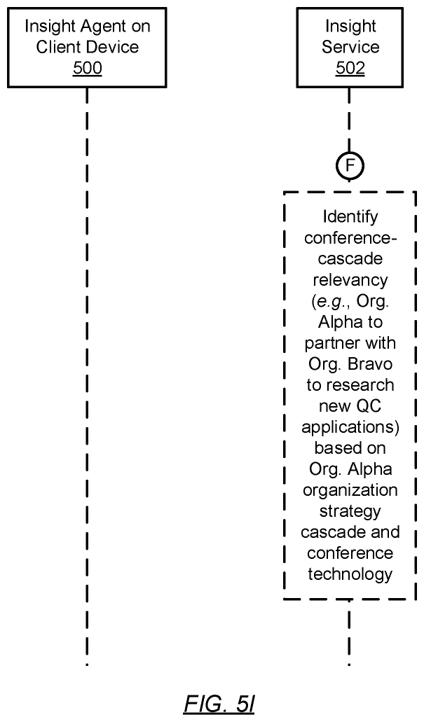

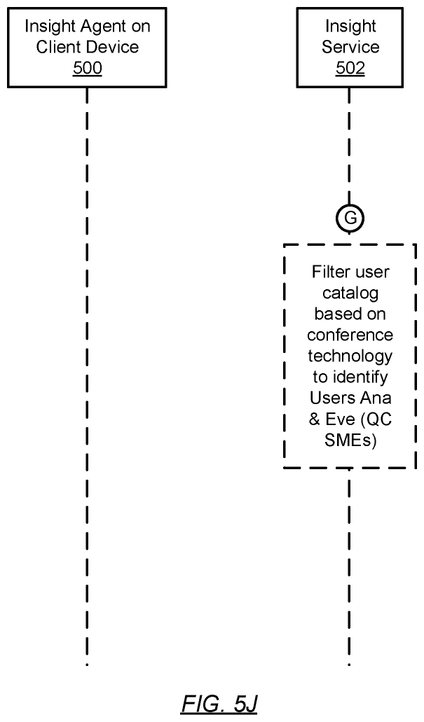

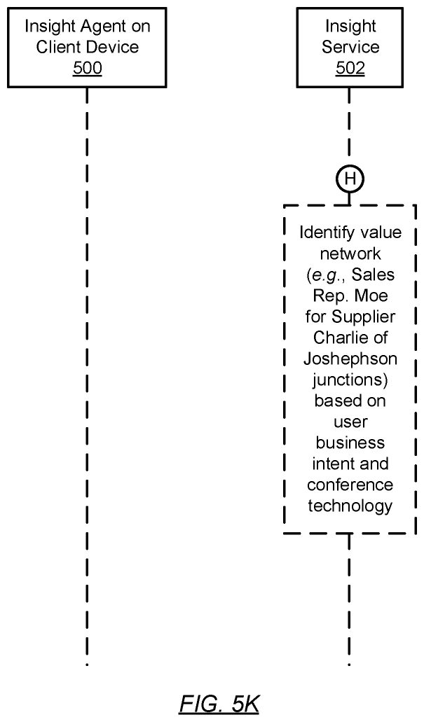

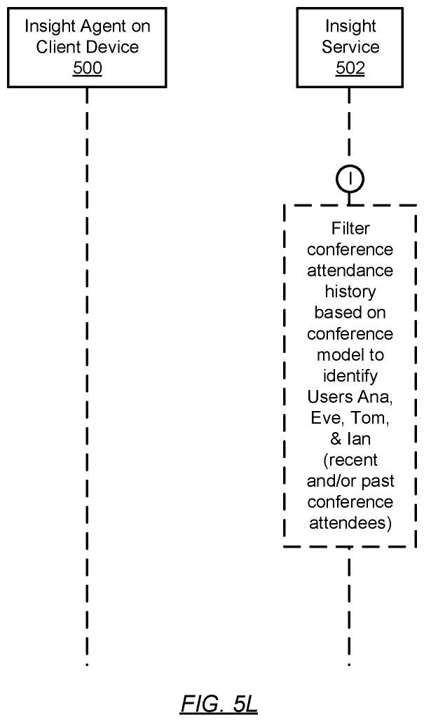

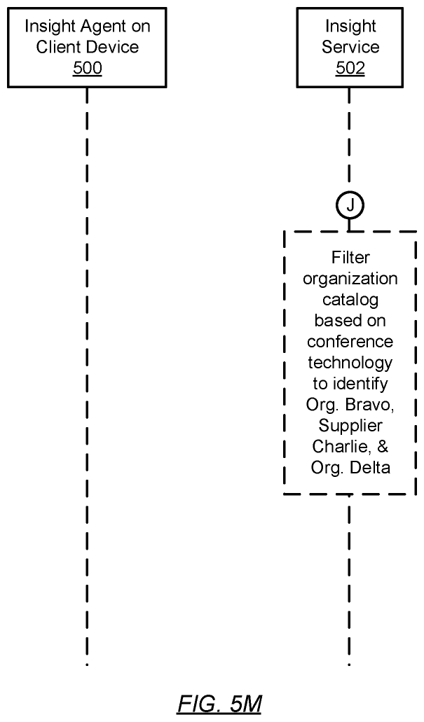

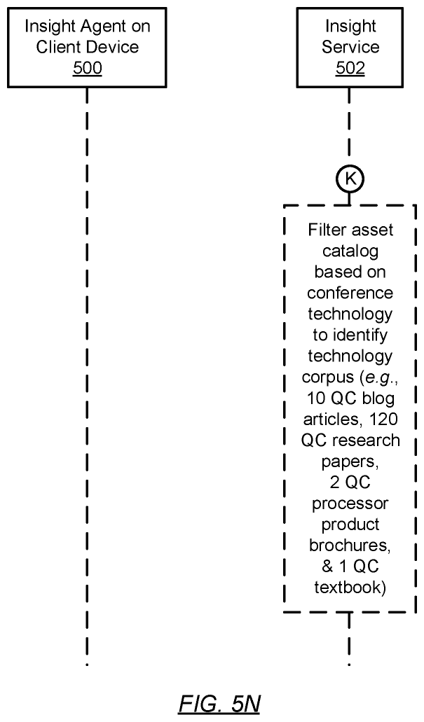

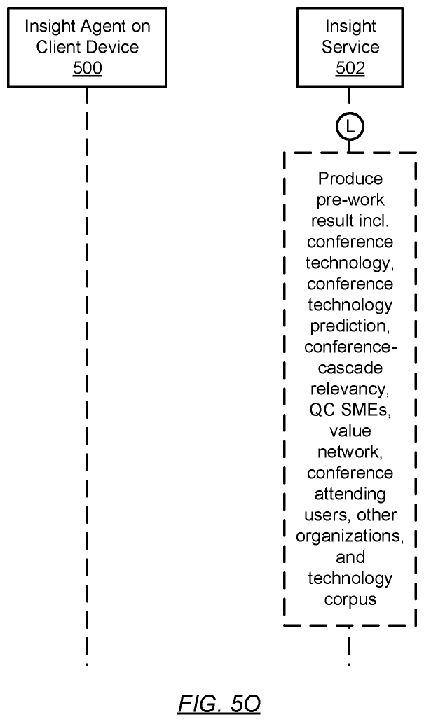

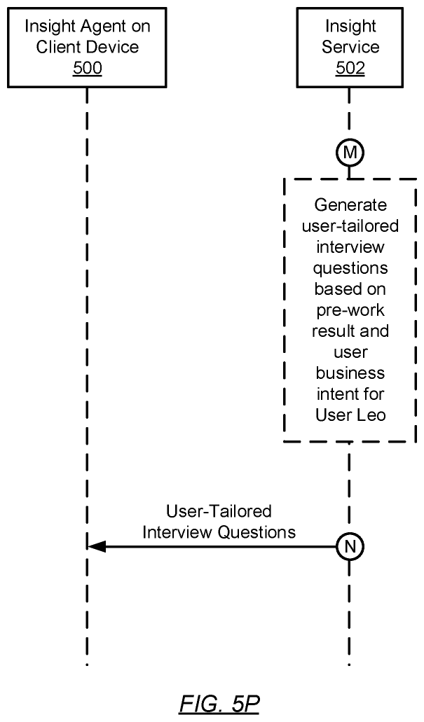

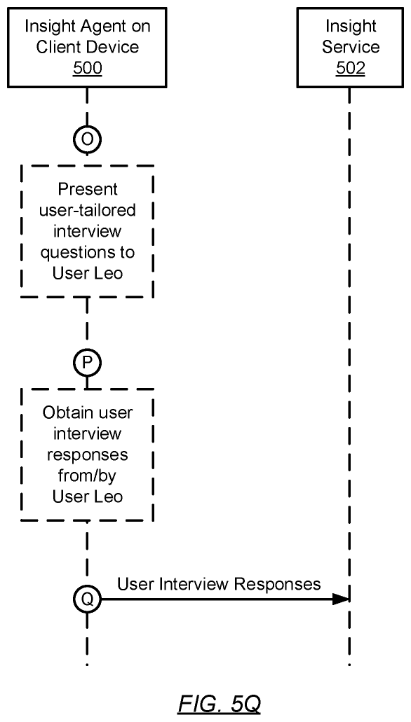

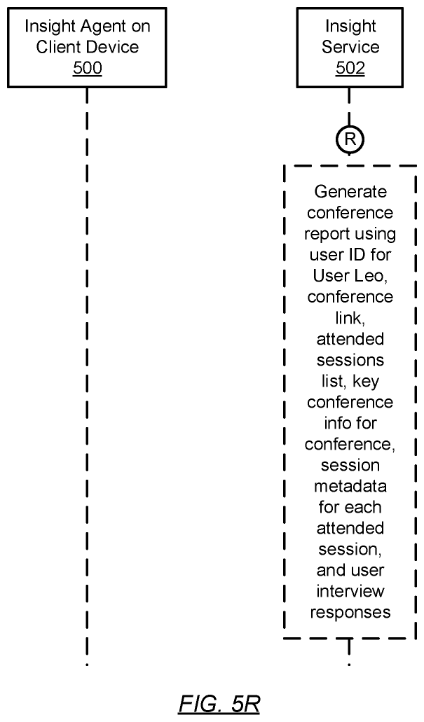

In one or many embodiment(s) disclosed herein, the insight service (106) may be configured with various capabilities or functionalities directed to digitally-assisted organization strategy. Said capabilities/functionalities may include: dynamic questioning intelligence, as described in FIGS. 3A-3D as well as exemplified in FIGS. 5A-5R, below. Further, the insight service (106) may perform other capabilities/functionalities without departing from the scope disclosed herein.

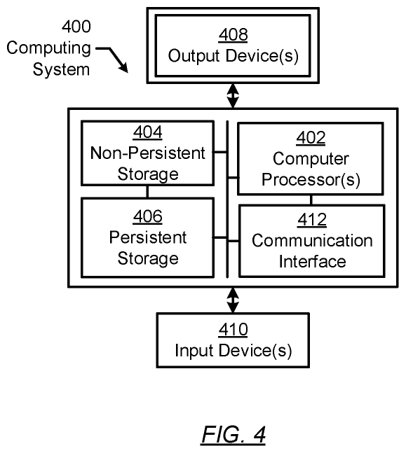

In one or many embodiment(s) disclosed herein, the insight service (106) may be implemented through on-premises infrastructure, cloud computing infrastructure, or any hybrid infrastructure thereof. The insight service (106), accordingly, may be implemented using one or more network servers (not shown), where each network server may represent a physical or a virtual network server. Additionally, or alternatively, the insight service (106) may be implemented using one or more computing systems each similar to the example computing system shown and described with respect to FIG. 4, below.

In one or many embodiment(s) disclosed herein, a client device (108) may represent any physical appliance or computing system operated by one or more organization users and configured to receive, generate, process, store, and/or transmit data/information (e.g., assets), as well as to provide an environment in which one or more computer programs (e.g., applications, insight agents, etc.) may execute thereon. An organization user, briefly, may refer to any individual whom is affiliated with, and fulfills one or more roles pertaining to, the organization that serves as the proprietor of the organization-internal environment (102). Further, in providing an execution environment for any computer programs, a client device (108) may include and allocate various resources (e.g., computer processors, memory, storage, virtualization, network bandwidth, etc.), as needed, to the computer programs and the tasks (or processes) instantiated thereby. Examples of a client device (108) may include, but are not limited to, a desktop computer, a laptop computer, a tablet computer, a smartphone, or any other computing system similar to the example computing system shown and described with respect to FIG. 4, below. Moreover, any client device (108) is described in further detail through FIG. 1B, below.

In one or many embodiment(s) disclosed herein, the organization-external environment (110) may represent any number of digital (e.g., IT) ecosystems not belonging to, and thus not managed by, an/the organization serving as the proprietor of the organization-internal environment (102). The organization-external environment (110), accordingly, may at least reference any public networks including any respective service(s) and data/information (e.g., assets). Further, the organization-external environment (110) may include one or more external data sources (112) and one or more third-party services (114). Each of these organization-external environment (110) subcomponents may or may not be co-located, and thus reside and/or operate, in the same physical or geographical space. Moreover, each of these organization-external environment (110) subcomponents is described below.

In one or many embodiment(s) disclosed herein, an external data source (112) may represent any data source (described above) not belonging to, and thus not managed by, an/the organization serving as the proprietor of the organization-internal environment (102). Any external data source (112), more specially, may refer to a location that stores at least a portion of the asset(s) found across any public networks. Further, depending on their respective access permissions, entities within the organization-internal environment (102), as well as those throughout the organization-external environment (110), may or may not be permitted to access any external data source (104) and, therefore, may or may not be permitted to access any asset(s) maintained therein.

Moreover, in one or many embodiment(s) disclosed herein, any external data source (112) may be implemented as physical storage (and/or as logical/virtual storage spanning at least a portion of the physical storage). The physical storage may, at least in part, include persistent storage, where examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) disclosed herein, a third party service (114) may represent information technology infrastructure configured for any number of purposes and/or applications. A third party, whom may implement and manage one or more third party services (114), may refer to an individual, a group of individuals, or another organization (i.e., not the organization serving as the proprietor of the organization-internal environment (102)) that serves as the proprietor of said third party service(s) (114). By way of an example, one such third party service (114), as disclosed herein may be exemplified by an automated machine learning (ML) service. A purpose of the automated ML service may be directed to automating the selection, composition, and parameterization of ML models. That is, more simply, the automated ML service may be configured to automatically identify one or more optimal ML algorithms from which one or more ML models may be constructed and fit to a submitted dataset in order to best achieve any given set of tasks. Further, any third party service (114) is not limited to the aforementioned specific example.

In one or many embodiment(s) disclosed herein, any third party service (114) may be implemented through on-premises infrastructure, cloud computing infrastructure, or any hybrid infrastructure thereof. Any third party service (114), accordingly, may be implemented using one or more network servers (not shown), where each network server may represent a physical or a virtual network server. Additionally, or alternatively, any third party service (114) may be implemented using one or more computing systems each similar to the example computing system shown and described with respect to FIG. 4, below.

In one or many embodiment(s) disclosed herein, the above-mentioned system (100) components, and their respective subcomponents, may communicate with one another through a network (not shown) (e.g., a local area network (LAN), a wide area network (WAN) such as the Internet, a mobile network, any other communication network type, or a combination thereof). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components and their respective subcomponents. Moreover, in communicating with one another, the above-mentioned system (100) components, and their respective subcomponents, may employ any combination of existing wired and/or wireless communication protocols.

While FIG. 1A shows a configuration of components and/or subcomponents, other system (100) configurations may be used without departing from the scope disclosed herein.

FIG. 1B shows a client device in accordance with one or more embodiments disclosed herein. The client device (108) (described above as well) (see e.g., FIG. 1A) may host or include one or more applications (116A-116N). Each application (116A-116N), in turn, may host or include an insight agent (118A-118N). Each of these client device (108) subcomponents is described below.

In one or many embodiment(s) disclosed herein, an application (116A-116N) (also referred to herein as a software application or program) may represent a computer program, or a collection of computer instructions, configured to perform one or more specific functions. Broadly, examples of said specific function(s) may include, but are not limited to, receiving, generating and/or modifying, processing and/or analyzing, storing or deleting, and transmitting data/information (e.g., assets) (or at least portions thereof). That is, said specific function(s) may generally entail one or more interactions with data/information either maintained locally on the client device (108) or remotely across one or more data sources. Examples of an application (116A-116N) may include a word processor, a spreadsheet editor, a presentation editor, a database manager, a graphics renderer, a video editor, an audio editor, a web browser, a collaboration tool or platform, and an electronic mail (or email) client. Any application (116A-116N), further, is not limited to the aforementioned specific examples.

In one or many embodiment(s) disclosed herein, any application (116A-116N) may be employed by one or more organization users, which may be operating the client device (108), to achieve one or more tasks, at least in part, contingent on the specific function(s) that the application (116A-116N) may be configured to perform. Said task(s) may or may not be directed to supporting and/or achieving any short-term and/or long-term goal(s) outlined by an/the organization with which the organization user(s) may be affiliated.

In one or many embodiment(s) disclosed herein, an insight agent (118A-118N) may represent a computer program, or a collection of computer instructions, configured to perform any number of tasks in support, or as extensions, of the capabilities or functionalities of the insight service (106) (described above) (see e.g., FIG. 1A). With respect to their assigned application (116A-116N), examples of said tasks, which may be carried out by a given insight agent (118A-118N), may include: detecting an initiation of their assigned application (116A-116N) by the organization user(s) operating the client device (108); monitoring any engagement (or interaction), by the organization user(s), with their assigned application (116A-116N) following the detected initiation thereof; identifying certain engagement/interaction actions, performed by the organization user(s), based on said engagement/interaction monitoring; executing any number of procedures or algorithms, relevant to one or more insight service (106) capabilities/functionalities, in response to one or more of the identified certain engagement/interaction actions; providing periodic and/or on-demand telemetry to the insight service (106), where said telemetry may include, for example, data/information requiring processing or analysis to be performed on/by the insight service (106); and receive periodic and/or on-demand updates (and/or instructions) from the insight service (106). Further, the tasks carried out by any insight agent (118A-118N) are not limited to the aforementioned specific examples.

While FIG. 1B shows a configuration of components and/or subcomponents, other client device (108) configurations may be used without departing from the scope disclosed herein. For example, in one or many embodiment(s) disclosed herein, not all of the application(s) (116A-116N), executing on the client device (108), may host or include an insight agent (118A-118N). That is, in said embodiment(s), an insight agent (118A-118N) may not be assigned to or associated with any of at least a subset of the application(s) (116A-116N) installed on the client device (108).

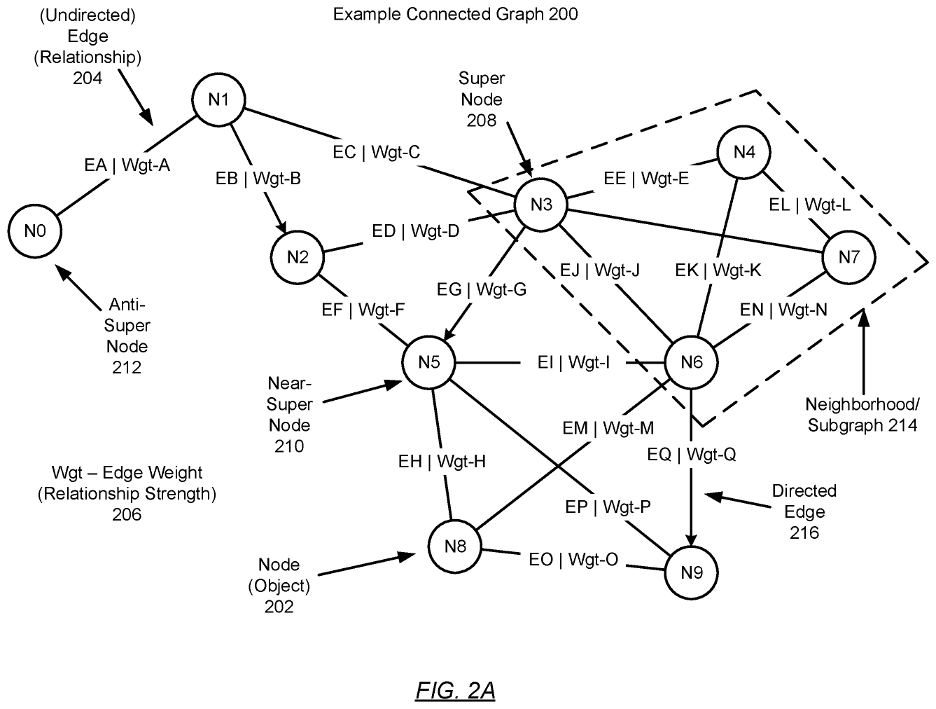

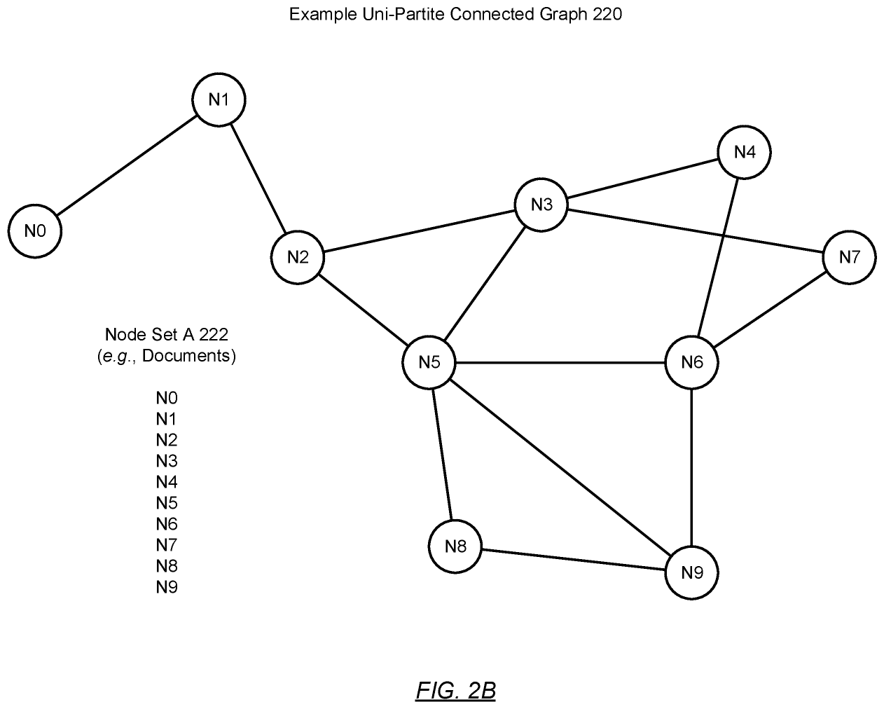

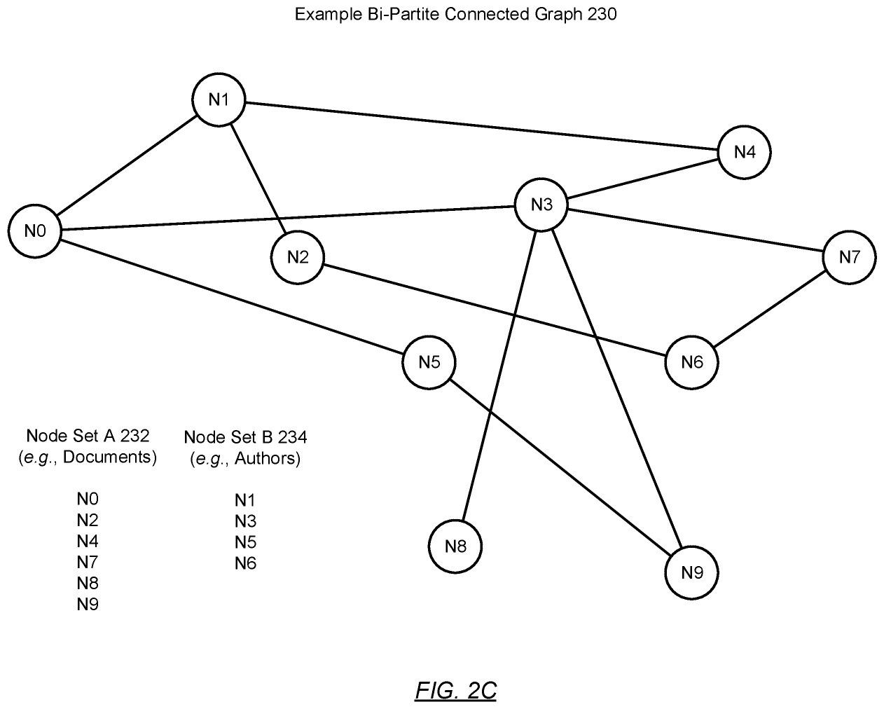

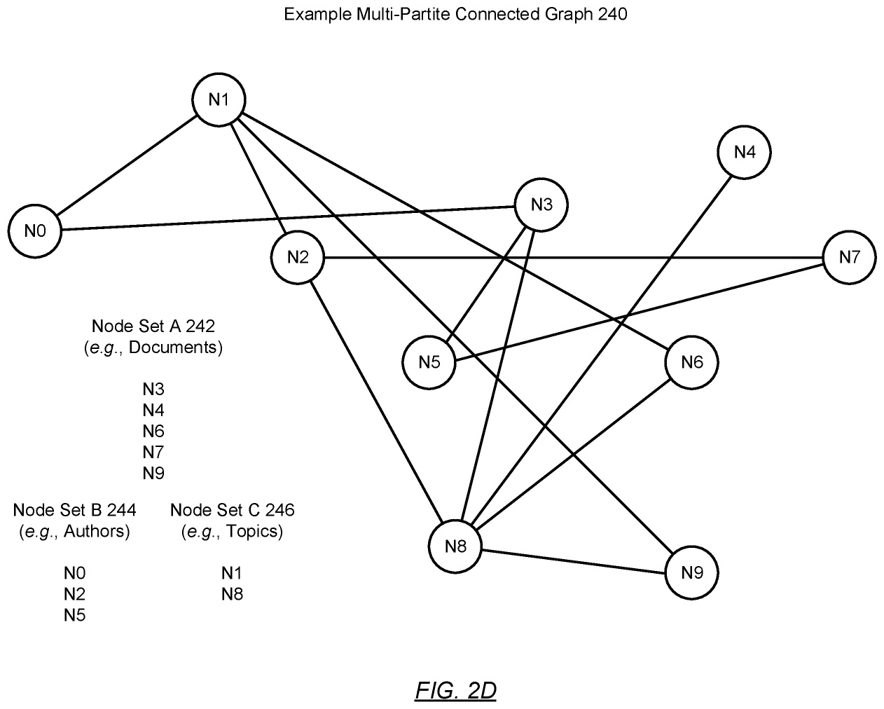

FIG. 2A shows an example connected graph in accordance with one or more embodiments disclosed herein. A connected graph (200), as disclosed herein, may refer to a set of nodes (202) (denoted in the example by the circles labeled N0, N1, N2, . . . , N9) interconnected by a set of edges (204, 216) (denoted in the example by the lines labeled EA, EB, EC, . . . , EQ between pairs of nodes). Each node (202) may represent or correspond to an object (e.g., a catalog entry, a record, specific data/information, a person, etc.) whereas each edge (204, 216), between or connecting any pair of nodes, may represent or correspond to a relationship, or relationships, associating the objects mapped to the pair of nodes. A connected graph (200), accordingly, may reference a data structure that reflects associations amongst any number, or a collection, of objects.

In one or many embodiment(s) disclosed herein, each node (202), in a connected graph (200), may also be referred to herein, and thus may serve, as an endpoint (of a pair of endpoints) of/to at least one edge (204). Further, based on a number of edges connected thereto, any node (202), in a connected graph (200), may be designated or identified as a super node (208), a near-super node (210), or an anti-super node (212). A super node (208) may reference any node where the number of edges, connected thereto, meets or exceeds a (high) threshold number of edges (e.g., six (6) edges). A near-super node (210), meanwhile, may reference any node where the number of edges, connected thereto, meets or exceeds a first (high) threshold number of edges (e.g., five (5) edges) yet lies below a second (higher) threshold number of edges (e.g., six (6) edges), where said second threshold number of edges defines the criterion for designating/identifying a super node (208). Lastly, an anti-super node (212) may reference any node where the number of edges, connected thereto, lies below a (low) threshold number of edges (e.g., two (2) edges).

In one or many embodiment(s) disclosed herein, each edge (204, 216), in a connected graph (200), may either be designated or identified as an undirected edge (204) or, conversely, as a directed edge (216). An undirected edge (204) may reference any edge specifying a bidirectional relationship between objects mapped to the pair of endpoints (i.e., pair of nodes (202)) connected by the edge. A directed edge (216), on the other hand, may reference any edge specifying a unidirectional relationship between objects mapped to the pair of endpoints connected by the edge.

In one or many embodiment(s) disclosed herein, each edge (204, 216), in a connected graph (200), may be associated with or assigned an edge weight (206) (denoted in the example by the labels Wgt-A, Wgt-B, Wgt-C, . . . , Wgt-Q). An edge weight (206), of a given edge (204, 216), may reflect a strength of the relationship(s) represented by the given edge (204, 216). Further, any edge weight (206) may be expressed as or through a positive numerical value within a predefined spectrum or range of positive numerical values (e.g., 0.1 to 1.0, 1 to 100, etc.). Moreover, across the said predefined spectrum/range of positive numerical values, higher positive numerical values may reflect stronger relationships, while lower positive numerical values may alternatively reflect weaker relationships.

In one or many embodiment(s) disclosed herein, based on an edge weight (206) associated with or assigned to an edge (204, 216) connected thereto, any node (202), in a connected graph (200), may be designated or identified as a strong adjacent node (not shown) or a weak adjacent node (not shown) with respect to the other endpoint of (i.e., the other node connected to the node (202) through) the edge (204, 216). That is, a strong adjacent node may reference any node of a pair of nodes connected by an edge, where an edge weight of the edge meets or exceeds a (high) edge weight threshold. Alternatively, a weak adjacent node may reference any node of a pair of nodes connected by an edge, where an edge weight of the edge lies below a (low) edge weight threshold.

In one or many embodiment(s) disclosed herein, a connected graph (200) may include one or more subgraphs (214) (also referred to as neighborhoods). A subgraph (214) may refer to a smaller connected graph found within a (larger) connected graph (200). A subgraph (214), accordingly, may include a node subset of the set of nodes (202), and an edge subset of the set of edges (204, 216), that form a connected graph (200), where the edge subset interconnects the node subset.

While FIG. 2A shows a configuration of components and/or subcomponents, other connected graph (200) configurations may be used without departing from the scope disclosed herein.

FIGS. 2B-2D show example k-partite connected graphs in accordance with one or more embodiments disclosed herein. Generally, any k-partite connected graph may represent a connected graph (described above) (see e.g., FIG. 2A) that encompasses k independent sets of nodes and a set of edges interconnecting (and thus defining relationships between) pairs of nodes: (a) both belonging to the same, single independent set of nodes in any (k=1)-partite connected graph; or (b) each belonging to a different independent set of nodes in any (k>1)-partite connected graph. Further, any k-partite connected graph, as disclosed herein, may fall into one of three possible classifications: (a) a uni-partite connected graph, where k=1; (b) a bi-partite connected graph, where k=2; or (c) a multi-partite connected graph, where k≥3.

Turning to FIG. 2B, an example uni-partite connected graph (220) is depicted. The uni-partite connected graph (220) includes one (k=1) independent set of nodes—i.e., a node set (222), which collectively maps or belongs to a single object class (e.g., documents).

Further, in the example, the node set is denoted by the circles labeled N0, N1, N2, . . . N9. Each said circle, in the node set (222), subsequently denotes a node that represents or corresponds to a given object (e.g., a document) in a collection of objects (e.g., a group of documents) of the same object class (e.g., documents).

Moreover, the uni-partite connected graph (220) additionally includes a set of edges (denoted in the example by the lines interconnecting pairs of nodes, where the first and second nodes in a given node pair belongs to the node set (222)). Each edge, in the example, thus reflects a relationship, or relationships, between any two nodes of the node set (222) (and, by association, any two objects of the same object class) directly connected via the edge.

Turning to FIG. 2C, an example bi-partite connected graph (230) is depicted. The bi-partite connected graph (230) includes two (k=2) independent sets of nodes—i.e., a first node set (232) and a second node set (234), where the former collectively maps or belongs to a first object class (e.g., documents) whereas the latter collectively maps or belongs to a second object class (e.g., authors).

Further, in the example, the first node set (232) is denoted by the circles labeled N0, N2, N4, N7, N8, and N9, while the second node set (234) is denoted by the circles labeled N1, N3, N5, and N6. Each circle, in the first node set (232), subsequently denotes a node that represents or corresponds to a given first object (e.g., a document) in a collection of first objects (e.g., a group of documents) of the first object class (e.g., documents). Meanwhile, each circle, in the second node set (234), subsequently denotes a node that represents or corresponds to a given second object (e.g., an author) in a collection of second objects (e.g., a group of authors) of the second object class (e.g., authors).

Moreover, the bi-partite connected graph (230) additionally includes a set of edges (denoted in the example by the lines interconnecting pairs of nodes, where a first node in a given node pair belongs to the first node set (232) and a second node in the given node pair belongs to the second node set (234)). Each edge, in the example, thus reflects a relationship, or relationships, between any one node of the first node set (232) and any one node of the second node set (234) (and, by association, any one object of the first object class and any one object of the second object class) directly connected via the edge.

Turning to FIG. 2D, an example multi-partite connected graph (240) is depicted. The multi-partite connected graph (240) includes three (k=3) independent sets of nodes—i.e., a first node set (242), a second node set (244), and a third node set (246). The first node set (242) collectively maps or belongs to a first object class (e.g., documents); the second node set (244) collectively maps or belongs to a second object class (e.g., authors); and the third node set (246) collectively maps or belongs to a third object class (e.g., topics).

Further, in the example, the first node set (242) is denoted by the circles labeled N3, N4, N6, N7, and N9; the second node set (244) is denoted by the circles labeled N0, N2, and N5; and the third node set (246) is denoted by the circles labeled N1 and N8. Each circle, in the first node set (242), subsequently denotes a node that represents or corresponds to a given first object (e.g., a document) in a collection of first objects (e.g., a group of documents) of the first object class (e.g., documents). Meanwhile, each circle, in the second node set (244), subsequently denotes a node that represents or corresponds to a given second object (e.g., an author) in a collection of second objects (e.g., a group of authors) of the second object class (e.g., authors). Lastly, each circle, in the third node set (246), subsequently denotes a node that represents or corresponds to a given third object (e.g., a topic) in a collection of third objects (e.g., a group of topics) of the third object class (e.g., topics).

Moreover, the multi-partite connected graph (240) additionally includes a set of edges (denoted in the example by the lines interconnecting pairs of nodes, where a first node in a given node pair belongs to one object class from the three available object classes, and a second node in the given node pair belongs to another object class from the two remaining object classes (that excludes the one object class to which the first node in the given node pair belongs)). Each edge, in the example, thus reflects a relationship, or relationships, between any one node of one object class (from the three available object classes) and any one node of another object class (from the two remaining object class excluding the one object class) directly connected via the edge.

FIGS. 3A and 3B show flowcharts describing a method for dynamic questioning intelligence in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 3A, in Step 300, an initiation of a conference interview program, by an organization user, is detected. In one or many embodiment(s) disclosed herein, the conference interview program may refer to any software application configured to question any user thereof (e.g., the organization user) about any conference(s) recently attended by the user. A conference, in turn, may reference a large, formal meeting organized around one or more themes (e.g., business, technology, etc.) discoursed through a combination of forums, seminars, workshops, presentations, etc. A conference may also host retailers and suppliers, representing organizations related to and/or involved in said theme(s), whom usually seek to find markets and customers from among the conference attendees. Further, detection of the initiation of the conference interview program may, for example, entail the receiving of telemetry from one or more insight agents (see e.g., FIG. 1B) executing on a client device operated by the organization user, where the conference interview program also executes on the aforementioned client device. The insight agent(s), accordingly, may be embedded within, or may otherwise be associated with, the conference interview program.

In Step 302, following initiation of the conference interview program (detected in Step 300), the organization user is prompted for a few preliminary inputs. In one or many embodiment(s) disclosed herein, the few preliminary inputs include a user identifier (ID), a conference link, and an attended sessions list. The user ID may refer to a character string (e.g., an account username, an employee number, etc.) that uniquely identifies the organization user within an organization (e.g., a commercial/business entity, a higher education school, a government agency, a research institute, etc.) with which the organization user is affiliated. The conference link, meanwhile, may refer to a universal resource locator (URL) associated with a conference website for the conference that had been recently attended by the organization user. The attended sessions list, lastly, may refer to a list of conference sessions (e.g., segments of a conference during which discussions tend to be directed to particular topics under the conference theme(s)) that had been attended by the organization user. Furthermore, the organization user may be prompted for said few preliminary inputs through, for example, a user interface of the conference interview program, where said prompting may be facilitated by the insight agent(s) executing on the client device (operated by the organization user) and associated with the conference interview program.

In Step 304, a user business intent is obtained. In one or many embodiment(s) disclosed herein, the user business intent may pertain to the organization user whom initiated the conference interview program (detected in Step 300) and, therefore, may be obtained using the user ID (obtained via prompting of the organization user in Step 302). Further, the user business intent may refer to information, respective to the organization user, which may pertain to or describe the engagement of the organization user within and/or outside their organization (e.g., a commercial business, an education institute, etc.). The user business intent, further, may be represented through a set of business intent parameters.

Examples of said business intent parameter(s) (as they pertain to any given organization user) may include, but is/are not limited to: one or more user organization roles (e.g., title(s) and/or position(s)) within an organization that may be associated with the given organization user; one or more other organization users within the organization with which the given organization user interacts and/or had interacted; one or more suppliers, distributors, customers, collaborators, and/or other actors outside the organization (also collectively referred to herein as one or more value networks) with which the given organization user interacts and/or had interacted; a search query history reflecting one or more past search queries, as well as the search topic(s) entailed, which had been previously submitted by the given organization user; one or more organization departments of the organization with which the given organization user is associated; one or more organization responsibilities (e.g., assigned project(s) or task(s)) within the organization that the given organization user is currently undertaking or had undertaken in the past; and one or more success metrics indicating a level of success that the aforementioned organization responsibility/responsibilities have brought to the organization. Said business intent parameter(s) is/are not limited to the aforementioned specific examples.

In Step 306, a conference website, associated with the conference that had been recently attended by the organization user, is accessed. In one or many embodiment(s) disclosed herein, said conference website may be accessed through the conference link (obtained via prompting of the organization user in Step 302). Further, tending to be the case for any website, the conference website may include a collection of webpages.

In Step 308, the conference website (accessed in Step 306) is subsequently ingested. In one or many embodiment(s) disclosed herein, ingestion of the conference website may, for example, entail applying the technique of data scraping to the entirety, or at least a portion, of the conference website. Further, through said ingestion, key conference information may be extracted or obtained. The key conference information, which may describe the conference, may include: a conference agenda providing an overview of what to expect throughout the conference; a list of one or more organizations sponsoring the conference; an abstract for each conference session, in a set of conference sessions, scheduled throughout the conference; and a list of conference speakers, or individuals leading discussions, centered on the conference theme(s), throughout the conference. Moreover, the key conference information is not limited to the aforementioned specific examples.

In Step 310, a conference model is built based on the key conference information (obtained in Step 308). In one or many embodiment(s) disclosed herein, the conference model may refer to an abstract representation (e.g., a data model) of the various information items, of the key conference information, and any relationships there-between. Further, the conference model may be constructed into a graph structure where the various information items, of the key conference information, may correspond, respectively, to a set of nodes forming the graph structure. The graph structure may further include a set of edges that interconnect the set of nodes based on identified relationships between the various items of the key conference information. Additionally, an edge weight may be assigned to one or more edges, in the set of edges, based at least on the user business intent (obtained in Step 304).

In Step 312, from the conference website (accessed in Step 306), a set of session webpages is identified. In one or many embodiment(s) disclosed herein, each session webpage, in the set of session webpages, may pertain or map to a conference session (also referred to hereinafter as an attended session), specified in the attended sessions list (obtained via prompting of the organization user in Step 302), that the organization user attended throughout the conference.

In Step 314, each session webpage, in the set of session webpages (identified in Step 312), is ingested. In one or many embodiment(s) disclosed herein, ingestion of any session webpage may, for example, entail applying the technique of data scraping to the entirety, or at least a portion, of the session webpage. Further, through said ingestion, session metadata may be extracted or obtained. The session metadata, which may describe any attended session, may include: a session title associated with the attended session; a session topic associated with the attended session; a list of session presenters, or individuals leading the discussion(s) centered on the session topic; and a list of session organizations each sponsoring the attended session. Moreover, the session metadata, for any given attended session, is not limited to the aforementioned specific examples.

In Step 316, for each attended session in the attended sessions list (obtained via prompting of the organization user in Step 302), a session model is built based on the session metadata respective thereto (obtained in Step 314). In one or many embodiment(s) disclosed herein, any session model may refer to an abstract representation (e.g., a data model) of the various information items, of the session metadata (respective to the session model), and any relationships there-between. Further, any session model may be constructed into a graph structure where the various information items, of the session metadata (respective to the session model), may correspond, respectively, to a set of nodes forming the graph structure. The graph structure may further include a set of edges that interconnect the set of nodes based on identified relationships between the various items of the session metadata (respective to the session model). Additionally, an edge weight may be assigned to one or more edges, in the set of edges, based at least on the user business intent (obtained in Step 304).

In Step 318, insight state is obtained. In one or many embodiment(s) disclosed herein, the insight state may reference any information (and/or knowledge/insights derived from said information) known to (and/or inferred by) the insight service. Further, said insight state may include, but is not limited to: an overall set (or superset) of technology predictions, an organization strategy cascade, a user catalog, a conference attendance history, an organization catalog, and an asset catalog.

In one or many embodiment(s) disclosed herein, any technology prediction (in the superset of technology predictions) may represent an inference, based on any and all information known to the insight service, as to a timeline indicative of when a particular emergent technology theme (e.g., trends, innovations, etc. in a given technology space) may shift (e.g., become a publicly available product, commodity, and/or service). The superset of technology predictions, accordingly, may represent numerous inferences pertaining to various emergent technology themes.

In one or many embodiment(s) disclosed herein, an organization strategy may reference a plan (or a sum of actions), intended to be pursued by an organization (e.g., the organization with which the organization user may be affiliated), directed to leveraging organization resources towards achieving one or more long-term goals. Said long-term goal(s) may, for example, relate to identifying or predicting future or emergent trends across one or more industries. An organization strategy cascade, meanwhile, may reference a scheme outlining a division or distribution of an organization strategy, in the form of smaller goals, projects, and other responsibilities, across the various units (e.g., departments), as well as across the organizational hierarchy (e.g., a tiered arrangement of organization personnel usually based on status or authority), of an organization.

In one or many embodiment(s) disclosed herein, a user catalog may refer to a data structure that maintains user metadata describing a set of organization users working for, or otherwise affiliated with, an organization. The user catalog, further, may organize said user metadata across a set of (user) catalog entries. Each (user) catalog entry, in the set of (user) catalog entries, may pertain to an organization user in the set of organization users and, therefore, may store user metadata particular to said organization user.

Examples of user metadata, for any given organization user, may include: one or more user identifiers (e.g., a username assigned to the given organization user within an organization, the personal name with which the given organization user may be referred, etc.); one or more user domains (e.g., one or more subjects, topics, specialties, and/or interests to which the given organization user contributes and in which the given organization user may be knowledgeable; and user contact information (e.g., personal and/or organization phone number(s) through which the given organization user may be reached via existing telephonic technologies, personal and/or organization email address(es) through which the given organization user may be reached via existing electronic mail technologies, etc.). Further, user metadata is not limited to the aforementioned specific examples.

In one or many embodiment(s) disclosed herein, a conference attendance history may refer to a data structure that maintains attendance records, and conference metadata, for a set of past conferences, which organization users of an organization (e.g., the organization with which the organization user may be affiliated) may have attended. The conference attendance history, further, may organize said attendance records and conference metadata across a set of attendance history entries. Each attendance history entry, in the set of attendance history entries, may pertain to a past conference in the set of past conferences and, therefore, may store an attendance record (e.g., a verified list of organization users whom attended the past conference) and conference metadata particular to said past conference.

Examples of conference metadata, for any given past conference, may include: a conference agenda providing an overview of the given past conference; a list of one or more organizations sponsoring the given past conference; an abstract for each conference session, in a set of conference sessions, scheduled throughout the given past conference; a list of conference speakers, or individuals leading discussions, centered on any conference theme(s), throughout the given past conference; and one or more references (if any) to related other past conference(s) (e.g., other past conference(s) identified by a same or similar conference name yet transpired at a different year). Further, conference metadata is not limited to the aforementioned specific examples.

In one or many embodiment(s) disclosed herein, an organization catalog may refer to a data structure that maintains organization metadata describing a set of (other) organizations, excluding the organization with which the organization user may be affiliated. The organization catalog, further, may organize said organization metadata across a set of (organization) catalog entries. Each (organization) catalog entry, in the set of (organization) catalog entries, may pertain to an (other) organization in the set of (other) organizations and, therefore, may store organization metadata particular to said (other) organization.

Examples of organization metadata, for any given (other) organization, may include: an identifier or name associated with the given (other) organization; a list of technologies and/or industries in which the given (other) organization is involved or predicted to be involved; a relationship status (e.g., competitor, collaborator, customer, supplier, distributor, etc.) describing a relationship between the organization and the given (other) organization; a brief description of the given (other) organization; an organization website link for the given (other) organization; and a list of contacts (if any) within the given (other) organization, including contact name(s), contact role(s), and contact information (e.g., telephone number(s), email address(es), etc.) for the contact(s). Further, organization metadata is not limited to the aforementioned specific examples.

In one or many embodiment(s) disclosed herein, an asset catalog may refer to a data structure that maintains asset metadata describing a set of assets (e.g., a collection of structured information/content such as tabular data or datasets, and/or of unstructured information/content such as text, videos, images, audio, multimedia, etc.). The asset catalog, further, may organize said asset metadata across a set of (asset) catalog entries. Each (asset) catalog entry, in the set of (asset) catalog entries, may pertain to an asset in the set of assets and, therefore, may store asset metadata particular to said asset.

Examples of asset metadata, for any given asset, may include: a brief description of the given asset; stewardship (or ownership) information (e.g., individual or group name(s), contact information, etc.) pertaining to the steward(s)/owner(s) of the given asset; a version character string reflective of a version or state of the given asset at/for a given point-in-time; one or more categories, topics, and/or aspects associated with the given asset; an asset identifier uniquely identifying the given asset; one or more tags, keywords, or terms further describing the given asset; a source identifier and/or location associated with an internal or external data source (see e.g., FIG. 1A) where the given asset resides or is maintained; and compliance information specifying laws, regulations, and standards surrounding the asset, as well as policies directed to data governance (e.g., availability, usability, integrity, and security) pertinent to the given asset. Further, asset metadata is not limited to the aforementioned specific examples.

Turning to FIG. 3B, in Step 320, a pre-work pipeline is performed. In one or many embodiment(s) disclosed herein, the pre-work pipeline may refer to a series of pre-work steps aiming to gather various information from which any interview question(s), tailored or customized for the organization user, may be derived. The pre-work pipeline, further, may be performed using the user business intent (obtained in 1704), the conference model (built in 1710), the session model(s) (built in 1716), and/or the insight state (obtained in Step 318). Moreover, in performing the pre-work pipeline, a pre-work result may be produced. Performance of the pre-work pipeline is illustrated and described in further detail with respect to FIGS. 3C and 3D, below.

In Step 322, a set of user-tailored interview questions is generated. In one or many embodiment(s) disclosed herein, the set of user-tailored interview questions may be directed to the conference that had been attended by the organization user. Further, the set of user-tailored interview questions may be generated based on the pre-work result (produced in Step 320). Moreover, the set of user-tailored interview questions may be customized, for the organization user, in view of (or considering) the user business intent (obtained in Step 304).

In one scenario, for example, an obtained user business intent may at least specify that the organization user holds a role of a salesperson in their respective organization. Based on their role as a salesperson, it may be further recognized that the organization user contributes value to their respective organization through the selling of products and/or services to customers. Subsequently, a set of user-tailored interview questions, customized based at least on said role and contribution value information associated with the organization user, may be generated.

In another scenario, by way of another example, an obtained user business intent may at least specify that the organization user holds a role of a research and development (R&D) engineer in their respective organization. Based on their role as a R&D engineer, it may be further recognized that the organization user contributes value to their respective organization through the creation and execution of ideas that lead to the building of new features and/or products for the organization. Subsequently, a set of user-tailored interview questions, customized based at least on said role and contribution value information associated with the organization user, may be generated.

In Step 324, the set of user-tailored interview questions (generated in Step 322) is subsequently presented or provided to the organization user. In one or many embodiment(s) disclosed herein, the set of user-tailored interview questions may be conveyed to the organization user through the user interface of the conference interview program, where said conveyance may be facilitated by the insight agent(s) executing on the client device (operated by the organization user) and associated with the conference interview program.

In Step 326, a set of user interview responses, from/by the organization user, is obtained. In one or many embodiment(s) disclosed herein, the set of user interview responses may address the set of user-tailored interview questions (provided in Step 324).

In Step 328, a conference report is produced. In one or many embodiment(s) disclosed herein, the conference report (e.g., in the form of a text document) may represent a detailed account of the conference, attended by the organization user, from the experiences and noted observations thereof respective to the organization user. Further, the conference report may include the user ID (obtained via prompting of the organization user in Step 302), the conference link (also obtained via prompting of the organization user in Step 302), the attended sessions list (also obtained via prompting of the organization user in Step 302), the key conference information (obtained in Step 308), the session metadata (obtained in Step 314) for each attended session in the attended sessions list, and at least a portion of the set of user interview responses (obtained in Step 326). The conference report, moreover, is not limited to the aforementioned specific information.

In Step 330, the conference report (produced in Step 328) is stored. In one or many embodiment(s) disclosed herein, the stored conference report may, going forward, become searchable and/or discoverable in the conference interview process of one or more other organization users whom may have attended the same conference as the organization user. In one or many other embodiment(s) disclosed herein, the stored conference report may, going forward, additionally become searchable and/or discoverable in the performance of one or more other capabilities or functionalities of the insight service.

In Step 332, one or more post-interview actions is/are performed. In one or many embodiment(s) disclosed herein, the post-interview action(s) may be centered around the conference report (stored in Step 330). Examples of post-interview actions may include: (a) notifying relevant organization users, including the organization user, of the conference report; (b) scheduling a collaborative meeting, centered on the conference report, amongst the notified relevant organization users; and (c) adding the conference report, as input, to any insight inference algorithm(s) employed by the insight service. Further, any post-interview action is not limited to the aforementioned specific examples.

FIGS. 3C and 3D show flowcharts describing a method for performing a pre-work pipeline in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 3C, in Step 340, a set of conference technologies is identified. In one or many embodiment(s) disclosed herein, any conference technology, in the set of conference technologies, may refer to an emergent technology theme (e.g., trends, innovations, etc. in a given technology space) that had been introduced in a conference attended by an organization user (discussed above) (see e.g., FIGS. 3A and 3B). Further, any conference technology, in the set of conference technologies, may have been identified using a technology classifier.

In one or many embodiment(s) disclosed herein, the technology classifier may refer to a machine learning model, based on any existing machine learning algorithm, which may be configured to: ingest certain model inputs; process said certain model inputs, at least based on a set of parameters and/or hyper-parameters (optimized through training of the base machine learning algorithm to arrive at, and thus define, the machine learning model); and output the set of conference technologies based on said processing of the certain model inputs. The certain model inputs, moreover, may include, but are not limited to: a conference model for the above-mentioned conference (built in Step 310 of FIG. 3A); and one or more session models (built in Step 316 of FIG. 3A) for one or more attended (conference) sessions in which the organization user participated throughout the conference.

In Step 342, one or more conference technology predictions is/are identified. In one or many embodiment(s) disclosed herein, the conference technology prediction(s) may be identified from, and thus may represent at least a subset of, an overall set (or superset) of technology predictions. Any conference technology prediction, accordingly, may reference a technology prediction relevant or related to one or more conference technologies in the set of conference technologies (identified in Step 340). Further, any technology prediction (and thus any conference technology prediction) may represent an inference, based on any and all information known to the insight service, as to a timeline indicative of when a particular emergent technology theme may shift (e.g., become a publicly available product, commodity, and/or service). In the case of any conference technology prediction, the aforementioned particular emergent technology theme may be one of the conference technologies, if not the sole conference technology, disclosed through the conference.

In Step 344, an organization strategy cascade is analyzed in view of (or considering) the set of conference technologies (identified in Step 340). In one or many embodiment(s) disclosed herein, the organization strategy cascade may reference a scheme outlining a division or distribution of an organization strategy, in the form of smaller goals, projects, and other responsibilities, across the various units (e.g., departments), as well as across the organizational hierarchy (e.g., a tiered arrangement of organization personnel usually based on status or authority), of an organization (e.g., the organization with which the organization user may be affiliated). Further, analysis of the organization strategy cascade may result in the identification of one or more conference-cascade relevancies. A conference-cascade relevancy, in turn, may refer to a relation of/connecting at least one of the conference technologies, in the set of conference technologies, to at least a portion of the organization strategy cascade.

In Step 346, a user catalog is filtered based on the set of conference technologies (identified in Step 340). In one or many embodiment(s) disclosed herein, filtering of the user catalog may, for example, entail topic matching (e.g., case-insensitive word or phrase matching) and/or semantic similarity calculation between the set of conference technologies and the user metadata, for organization users, maintained across the (user) catalog entries of the user catalog. Further, said filtering may result in the identification of one or more (user) catalog entries, where each identified (user) catalog entry includes user metadata, which, at least in part, reflects or has relevance to at least one conference technology in the set of conference technologies. The identified one or more (user) catalog entries, in turn, map to one or more organization users (e.g., other organization user(s) that is/are not the organization user), respectively, whom may be interested, and/or whom may be considered a subject matter expert, in at least one conference technology in the set of conference technologies.

In Step 348, a set of value networks is filtered based on the set of conference technologies (identified in Step 342). In one or many embodiment(s) disclosed herein, the set of value networks may, foremost, be extracted from, and thus may represent at least a portion of, a user business intent (obtained in Step 302 of FIG. 3A) for the organization user. A value network, in turn, may refer to any group of actors (e.g., suppliers, distributors, customers, collaborators, etc.) outside the organization with which the organization user may be affiliated and with which the organization user interacts and/or had interacted. Filtering of the set of value networks, subsequently, may, for example, entail topic matching (e.g., case-insensitive word or phrase matching) and/or semantic similarity calculation between the set of conference technologies and network metadata for each value network in the set of value networks. Further, said filtering may result in the identification of a value network subset including at least one value network, in the set of value networks, that has relevance to at least one conference technology in the set of conference technologies.

In Step 350, a conference attendance history is filtered based on the conference model (built in Step 310 of FIG. 3A). In one or many embodiment(s) disclosed herein, filtering of the conference attendance history may, for example, entail topic matching (e.g., case-insensitive word or phrase matching) and/or semantic similarity calculation between the conference model and conference metadata, for a set of past conferences (including the recent conference attended by the organization user), maintained across the attendance history entries of the conference attendance history. Further, said filtering may result in the identification of one or more attendance history entries, where each identified attendance history entry includes conference metadata, which, at least in part, reflects or has relevance to the conference of which the conference model is representative. Each identified attendance history entry, moreover, stores an attendance record that lists one or more organization users that had attended the past conference mapped to the identified attendance history entry. Accordingly, filtering of the conference attendance history may lead to the identification of other attending organization user(s) (e.g., excluding the organization user) whom had attended also attended the recent conference, attended by the organization user, and/or any other past conference(s) (e.g., transpiring in the past year(s)) that hold the same or similar conference name as the recent conference.

Turning to FIG. 3D, in Step 352, an organization catalog is filtered based on the set of conference technologies (identified in Step 340). In one or many embodiment(s) disclosed herein, filtering of the organization catalog may, for example, entail topic matching (e.g., case-insensitive word or phrase matching) and/or semantic similarity calculation between the set of conference technologies and the organization metadata, for other organizations (e.g., excluding the organization with which the organization user may be affiliated), maintained across the (organization) catalog entries of the organization catalog. Further, said filtering may result in the identification of one or more (organization) catalog entries, where each identified (organization) catalog entry includes organization metadata, which, at least in part, reflects or has relevance to at least one conference technology in the set of conference technologies. The identified one or more (organization) catalog entries, in turn, map to one or more other organizations, respectively, which may be involved, or is predicted to be involved, in at least one conference technology in the set of conference technologies.

In Step 354, an asset catalog is filtered based on the set of conference technologies (identified in Step 340). In one or many embodiment(s) disclosed herein, filtering of the asset catalog may, for example, entail topic matching (e.g., case-insensitive word or phrase matching) and/or semantic similarity calculation between each conference technology, in the set of conference technologies, and the asset metadata, for assets, maintained across the (asset) catalog entries of the asset catalog. Further, said filtering may result in the identification of one or more sets of (asset) catalog entries, where each identified set of (asset) catalog entries includes asset metadata, which, at least in part, reflects or has relevance to a given conference technology in the set of conference technologies. Each identified set of (asset) catalog entries, in turn, map to an identified set of assets (and, more specifically, asset(s) in the form of text documents such as papers, books, reports, etc.), respectively, that at least discuss or disclose a given conference technology in the set of conference technologies. Moreover, as used herein, any identified set of assets, directed to a given conference technology, may also be referred to as a technology corpus.

In Step 356, a pre-work result is produced. In one or many embodiment(s) disclosed herein, the pre-work result may represent an outcome of, or the information gained from/by, the pre-work pipeline. The pre-work result, accordingly, may include, but is not limited to: the set of conference technologies (identified in Step 340); the conference prediction(s) (identified in Step 342); the at least one conference-cascade relevancy (identified in Step 344); the (other) organization user(s) (identified in Step 346); the at least one value network (identified in Step 348); the (other) attending organization user(s) (identified in Step 350); the other organization(s) (identified in Step 352); and the at least one technology corpus (identified in Step 354).

FIG. 4 shows an example computing system in accordance with one or more embodiments disclosed herein. The computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment disclosed herein, the computer processor(s) (402) may be an integrated circuit for processing instructions. For example, the computer processor(s) may be one or more cores or micro-cores of a central processing unit (CPU) and/or a graphics processing unit (GPU). The computing system (400) may also include one or more input devices (410), such as a touchscreen, keyboard, mouse, microphone, touchpad, electronic pen, or any other type of input device. Further, the communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

In one embodiment disclosed herein, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments disclosed herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments disclosed herein.

FIGS. 5A-5R show an example scenario in accordance with one or more embodiments disclosed herein. The example scenario, illustrated through FIGS. 5A-5R and described below, is for explanatory purposes only and not intended to limit the scope disclosed herein.

Hereinafter, consider the following example scenario whereby an organization user, identified as Leo, has returned from attending a conference centered around quantum computing (QC) and, therefore, seeks to report on his experiences and observations while having attended said conference. To that end, Leo initiates a software application on his work laptop, or client device, employed by his affiliated organization, identified as Organization Alpha (or for short, Org. Alpha), where the software application (e.g., a conference interview program) is configured to inquire Leo with respect to the conference he recently had attended. The software application, further, relies on the disclosed capability of dynamic questioning intelligence by the insight service, and by extension, the insight agent executing on the client device and embedded within the software application, to provide a more human conversional line of questioning when inquiring Leo regarding the conference.

Interactions amongst various actors—e.g., the Insight Agent on the Client Device (500), the latter of which operated by Leo, and the Insight Service (502)—are illustrated in conjunction with components shown across FIGS. 5A-5R and described (in an itemized manner) below. Said interactions, as well as processes performed on/by any particular actor may follow embodiments disclosed herein pertaining to dynamic questioning intelligence as applied to the circumstances of the example scenario.

Turning to FIG. 5A:
1. Following initiation of the conference interview program by User Leo, the Insight Agent on the Client Device (500), the latter of which is being operated by User Leo, detects said initiation
2. The Insight Agent on the Client Device (500) prompts, via a user interface of the conference interview program, User Leo for (and subsequently obtains) a user identifier (e.g., User Leo ID), a conference link (e.g., www.quantumconf.com), and an attended sessions list (e.g., including conference sessions entitled “A Commercialization Roadmap for Quantum Processors” and “Use Cases of Quantum Computing for Space Exploration”)

Turning to FIG. 5B:
3. The Insight Agent on the Client Device (500) submits the user identifier (ID), conference link, and the attended sessions list to the Insight Service (502)
4. Based on the user ID (e.g., User Leo ID), the Insight Service (502) obtains a user business intent associated with User Leo, where the obtained user business intent at least specifies that Leo is a materials engineer in an engineering department of Org. Alpha
5. Using the conference link (e.g., www.quantumconf.com) for the conference attended by User Leo, the Insight Service (502) accesses a conference website for said conference

Turning to FIG. 5C:
6. The Insight Service (502) proceeds to ingest the conference website, via data scraping, to obtain key conference information (e.g., conference agenda, list of conference sponsors, conference session abstracts, list of conference speakers, etc.)
7. Based on the key conference information, the Insight Service (502) builds a conference model of the conference

Turning to FIG. 5D:
8. From ingesting the conference website earlier, the Insight Service (502) identifies a session webpage, amongst the conference website, for each attended (conference) session specified in the attended sessions list (e.g., including conference sessions entitled “A Commercialization Roadmap for Quantum Processors” and “Use Cases of Quantum Computing for Space Exploration”)
9. The Insight Service (502) subsequently ingests the session webpage, for each attended session, to obtain session metadata (e.g., session title, session topic, list of session presenters, list of session sponsors, etc.) describing the respective attended session

Turning to FIG. 5E:
A. Based on the session metadata, the Insight Service (502) builds a session model for each attended session
B. The Insight Service (502) obtains insight state including a superset of technology predictions for various technologies, an organization strategy cascade for Org. Alpha, a user catalog maintaining user metadata for users (e.g., employees) of Org. Alpha, a conference attendance history maintaining attendance records and conference metadata for recent and past conferences, an organization catalog maintaining organization metadata for various other organizations, and an asset catalog maintaining asset metadata for various assets

Turning to FIG. 5F:
C. Using the user business intent for User Leo, the conference model, the session models of the two attended sessions, and the insight state, the Insight Service (502) commences a pre-work pipeline

Turning to FIG. 5G:
D. As part of the pre-work pipeline, the Insight Service (502) identifies a conference technology (e.g., quantum processors) associated with the conference using a technology classifier fed with the conference model and the session models

Turning to FIG. 5H:
E. As part of the pre-work pipeline, the Insight Service (502) identifies a conference technology prediction (e.g., cloud service providers will begin integrating QC into their services in 5-10 years) from the superset of technology predictions and based on the conference technology

Turning to FIG. 5I:
F. As part of the pre-work pipeline, the Insight Service (502) identifies a conference-cascade relevancy (e.g., in the upcoming year, Org. Alpha intends to partner with Organization (or Org.) Bravo in researching new QC applications) based on the Org. Alpha organization strategy cascade and the conference technology

Turning to FIG. 5J:
G. As part of the pre-work pipeline, the Insight Service (502) filters the user catalog based on the conference technology and, subsequently, identifies Users Ana and Eve whom also work for Org. Alpha and are considered QC subject matter experts (SMEs)

Turning to FIG. 5K:
H. As part of the pre-work pipeline, the Insight Service (502) identifies a value network (e.g., a sales representative, identified as Moe, for an organization, identified as Supplier Charlie, that specializes in the production and sale of Joshephson junctions that serve as base materials used in superconducting qubits pertinent to constructing most existing quantum processors) from the user business intent for User Leo and based on the conference technology

Turning to FIG. 5L:
I. As part of the pre-work pipeline, the Insight Service (502) filters the conference attendance history based on the conference model and, subsequently, identifies Users Ana, Eve, Tom, and Ian as other Org. Alpha employees whom attended the conference and/or any past conferences of a same/similar conference name

Turning to FIG. 5M:
J. As part of the pre-work pipeline, the Insight Service (502) filters the organization catalog based on the conference technology and, subsequently, identifies Org. Bravo, Supplier Charlie, and Organization (or Org.) Delta as players in the quantum processors space

Turning to FIG. 5N:
K. As part of the pre-work pipeline, the Insight Service (502) filters the asset catalog based on the conference technology and, subsequently, identifies a technology corpus at least relevant or related to quantum processors, where the technology corpus includes 10 QC blog articles, 120 QC research papers, 2 quantum processor product brochures, and 1 QC textbook

Turning to FIG. 5O:
L. Finishing the pre-work pipeline, the Insight Service (502) produces a pre-work result including the conference technology (e.g., quantum processors), the conference technology prediction (e.g., cloud service providers will begin integrating QC into their services in 5-10 years), the conference-cascade relevancy (e.g., in the upcoming year, Org. Alpha intends to partner with Org. Bravo in researching new QC applications), QC SMEs (e.g., Users Ana and Eve) working for Org. Alpha, the value network (e.g., Sales Rep. Moe for Supplier Charlie), other recent and/or past conference attendees (e.g., Users Ana, Eve, Tom, and Ian), other players (e.g., Org. Bravo, Supplier Charlie, and Org. Delta) in the quantum processors space, and the technology corpus

Turning to FIG. 5P:
M. Based on the pre-work result and considering the user business intent (e.g., which at least specifies that User Leo is a materials engineer in an engineering department of Org. Alpha) for User Leo, the Insight Service (502) generates a set of user-tailored interview questions concerning the conference recently attended by User Leo
N. The Insight Service (502) then relays the set of user-tailored interview questions to the Insight Agent on the Client Device (500)

Turning to FIG. 5Q:
O. The Insight Agent on the Client Device (500) presents, via the user interface of the conference interview program, the set of user-tailored interview questions to User Leo
P. After some toiling by User Leo, the Insight Agent on the Client Device (500) obtains a set of user interview responses addressing the set of user-tailored interview questions
Q. The Insight Agent on the Client Device (500) submits the set of user interview responses to the Insight Service (502)

Turning to FIG. 5R:
R. The Insight Service (502) generates a conference report at least using the user ID (e.g., User Leo ID) for User Leo, the conference link (e.g., www.quantumconf.com) for the conference attended by User Leo, the attended sessions list (e.g., including conference sessions entitled “A Commercialization Roadmap for Quantum Processors” and “Use Cases of Quantum Computing for Space Exploration”), the key conference information (e.g., conference agenda, list of conference sponsors, conference session abstracts, list of conference speakers, etc.) associated with the conference, the session metadata (e.g., session title, session topic, list of session presenters, list of session sponsors, etc.) describing the two attended sessions specified in the attended sessions list, and the user interview responses; from here, the Insight Service (502) stores the conference report and may then proceed to perform any number of post-interview actions (see e.g., Step 332 of FIG. 3B)

While the embodiments disclosed herein have been described with respect to a limited number of embodiments, those skilled in the art, having benefit of this disclosure, will appreciate that other embodiments can be devised which do not depart from the scope disclosed herein as disclosed herein. Accordingly, the scope disclosed herein should be limited only by the attached claims.

What is claimed is:

1. A method for intelligent dynamic questioning, the method comprising:
detecting an initiation, by an organization user, of a conference interview program configured to question the organization user about a conference attended thereby;
obtaining a user business intent for the organization user;
building a conference model for the conference;
performing a pre-work pipeline, using the user business intent, the conference model, and an insight state, to produce a pre-work result;
generating a set of user-tailored interview questions based on the pre-work result and considering the user business intent; and
providing, through the conference interview program, the set of user-tailored interview questions to the organization user.

2. The method of claim 1, wherein the user business intent comprises an organization role within an organization with which the organization user is affiliated, at least one other organization user of the organization with which the organization user interacts, at least one value network outside the organization with which the organization user interacts, a search query history associated with the organization user, and at least one organization responsibility that the organization user is undertaking.

3. The method of claim 1, the method further comprising:
prior to building the conference model:
prompting the organization user for a conference link associated with the conference;
accessing a conference website using the conference link; and
ingesting the conference website to obtain key conference information describing the conference,
wherein the conference model is built based on the key conference information.

4. The method of claim 1, wherein the insight state comprises a set of technology predictions, an organization strategy cascade for an organization with which the organization user is affiliated, a user catalog comprising user metadata describing a set of organization users comprising the organization user, a conference attendance history at least associated with the conference, an organization catalog comprising organization metadata describing a set of other organizations excluding the organization, and an asset catalog comprising asset metadata describing a set of assets.

5. The method of claim 4, wherein performing the pre-work pipeline, using the user business intent, the conference model, and the insight state to produce the pre-work result, comprises:
feeding the conference model through a technology classifier to identify at least one conference technology associated with the conference;
identifying, from the set of technology predictions, at least one conference technology prediction relevant to the at least one conference technology; and
producing the pre-work result comprising the at least one conference technology and the at least one conference technology prediction.

6. The method of claim 5, wherein performing the pre-work pipeline, using the user business intent, the conference model, and the insight state, to produce the pre-work result, further comprises:
analyzing, in consideration of the at least one conference technology, the organization strategy cascade to identify at least one conference-cascade relevancy,
wherein each conference-cascade relevancy of the at least one conference-cascade relevance comprises a relation connecting the at least one conference technology to the organization strategy cascade,
wherein the pre-work result further comprises the at least one conference-cascade relevancy.

7. The method of claim 5, wherein performing the pre-work pipeline, using the user business intent, the conference model, and the insight state, to produce the pre-work result, further comprises:
filtering, based on the at least one conference technology, the user catalog to identify at least one other organization user,
wherein each other organization user of the at least one other organization user is at least one selected from a group comprising interested in, and a subject matter expert of, the at least one conference technology,
wherein the pre-work result further comprises the at least one other organization user.

8. The method of claim 5, wherein performing the pre-work pipeline, using the user business intent, the conference model, and the insight state, to produce the pre-work result, further comprises:
filtering, based on the conference model, the conference attendance history to identify at least one attending organization user excluding the organization user,
wherein each attending organization user of the at least one attending organization user is another organization user had that attended at least one selected from a group comprising the conference and a past conference related to the conference,
wherein the pre-work result further comprises the at least one attending organization user.

9. The method of claim 5, wherein performing the pre-work pipeline, using the user business intent, the conference model, and the insight state, to produce the pre-work result, further comprises:
filtering, based on the at least one conference technology, the organization catalog to identify at least one other organization,
wherein each other organization of the at least one other organization is one selected from a group comprising involved with, and predicted to be involved with, the at least one conference technology,
wherein the pre-work result further comprises the at least one other organization.

10. The method of claim 5, wherein performing the pre-work pipeline, using the user business intent, the conference model, and the insight state, to produce the pre-work result, further comprises:
filtering, based on the at least one conference technology, the asset catalog to identify at least one technology corpus,
wherein each technology corpus of the at least one technology corpus corresponds respectively to a conference technology of the at least one conference technology, and comprises at least one asset relevant to the conference technology,
wherein the pre-work result further comprises the at least one technology corpus.

11. The method of claim 5, wherein performing the pre-work pipeline, using the user business intent, the conference model, and the insight state, to produce the pre-work result, further comprises:
extracting, from the user business intent, a set of value networks with which the organization user interacts;
filtering, based on the at least one conference technology, the set of value networks to identify a value network subset from the set of value networks,
wherein each value network of the value network subset is relevant to the at least one conference technology,
wherein the pre-work result further comprises the value network subset.

12. The method of claim 5, the method further comprising:
prior to performing the pre-work pipeline:
prompting the organization user for a conference link associated with the conference and an attended sessions list comprising at least one attended session of the conference that the organization user attended;
accessing a conference website using the conference link;
identifying, within the conference website, at least one session webpage respectively associated with the at least one attended session;
ingesting the at least one session webpage to obtain session metadata; and
building, from the session metadata, a session model for each attended session of the at least one attended session to obtain at least one session model,
wherein the pre-work pipeline is performed further using the at least one session model,
wherein the at least one conference technology is identified by further feeding the at least one session model through the technology classifier.

13. The method of claim 1, the method further comprising:
obtaining, from the organization user and through the conference interview program, a set of user interview responses addressing the set of user-tailored interview questions;
producing a conference report comprising at least a portion of the set of user interview responses; and
performing a post-interview action at least based on the conference report.

14. A non-transitory computer readable medium (CRM) comprising computer readable program code, which when executed by a computer processor, enables the computer processor to perform a method for intelligent dynamic questioning, the method comprising:
detecting an initiation, by an organization user, of a conference interview program configured to question the organization user about a conference attended thereby;
obtaining a user business intent for the organization user;
building a conference model for the conference;
performing a pre-work pipeline, using the user business intent, the conference model, and an insight state, to produce a pre-work result;
generating a set of user-tailored interview questions based on the pre-work result and considering the user business intent; and
providing, through the conference interview program, the set of user-tailored interview questions to the organization user.

15. The non-transitory CRM of claim 14, wherein the insight state comprises a set of technology predictions, an organization strategy cascade for an organization with which the organization user is affiliated, a user catalog comprising user metadata describing a set of organization users comprising the organization user, a conference attendance history at least associated with the conference, an organization catalog comprising organization metadata describing a set of other organizations excluding the organization, and an asset catalog comprising asset metadata describing a set of assets.

16. The non-transitory CRM of claim 15, wherein performing the pre-work pipeline, using the user business intent, the conference model, and the insight state to produce the pre-work result, comprises:
feeding the conference model through a technology classifier to identify at least one conference technology associated with the conference;
identifying, from the set of technology predictions, at least one conference technology prediction relevant to the at least one conference technology; and
producing the pre-work result comprising the at least one conference technology and the at least one conference technology prediction.

17. The non-transitory CRM of claim 16, wherein performing the pre-work pipeline, using the user business intent, the conference model, and the insight state, to produce the pre-work result, further comprises:
filtering, based on the at least one conference technology, the user catalog to identify at least one other organization user,
wherein each other organization user of the at least one other organization user is at least one selected from a group comprising interested in, and a subject matter expert of, the at least one conference technology,
wherein the pre-work result further comprises the at least one other organization user.

18. The non-transitory CRM of claim 16, wherein performing the pre-work pipeline, using the user business intent, the conference model, and the insight state, to produce the pre-work result, further comprises:
filtering, based on the at least one conference technology, the asset catalog to identify at least one technology corpus,
wherein each technology corpus of the at least one technology corpus corresponds respectively to a conference technology of the at least one conference technology, and comprises at least one asset relevant to the conference technology,
wherein the pre-work result further comprises the at least one technology corpus.

19. The non-transitory CRM of claim 16, wherein performing the pre-work pipeline, using the user business intent, the conference model, and the insight state, to produce the pre-work result, further comprises:
extracting, from the user business intent, a set of value networks with which the organization user interacts;
filtering, based on the at least one conference technology, the set of value networks to identify a value network subset from the set of value networks,
wherein each value network of the value network subset is relevant to the at least one conference technology,
wherein the pre-work result further comprises the value network subset.

20. A system, the system comprising:
a client device; and
an insight service operatively connected to the client device, and comprising a computer processor configured to perform a method for intelligent dynamic questioning, the method comprising:
detecting an initiation, by an organization user operating the client device, of a conference interview program configured to question the organization user about a conference attended thereby,
wherein the conference interview program is executing on the client device;
obtaining a user business intent for the organization user;
building a conference model for the conference;
performing a pre-work pipeline, using the user business intent, the conference model, and an insight state, to produce a pre-work result;
generating a set of user-tailored interview questions based on the pre-work result and considering the user business intent; and
providing, through the conference interview program, the set of user-tailored interview questions to the organization user.
